(19) United States
(12) Patent Application Publication
(10) Pub. No.: US 2007/0234328 A1
(43) Pub. Date: Oct. 4, 2007

(54) File handling for test environments

(75) Inventors: Jared W. Wilson, Sammamish, WA (US); Michael P. Robinson, Bellevue, WA (US); Orville Jay Potter, Seattle, WA (US); Peter Gerber, Seattle, WA (US); David M. Foltz, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/365,242

(22) Filed: Mar. 1, 2006

(51) Int. Cl. G06F 9/44

(52) U.S. Cl. 717/162

(57) ABSTRACT

Test software on a test client dynamically locates necessary files by replacing indirect file references in test code with actual file paths. File paths are determined using one or more root paths couple with one or more test parameters being used as a portion of the actual file path. Multiple root paths may be provided in a prioritized list, such that if a file is not found in a first location, additional locations are checked. Test software on a test controller receives a command to perform a test run and queries a data store for test information. A message is assembled using query results and delivered to one or more test clients for execution.

### BACKGROUND

Testing software can be a time-consuming and tedious process. As software developers produce incremental builds of an application, each may be tested to ensure that the application performs as expected. The scope of software testing can vary, from an isolated test performed on a single machine by a software developer, to a high-volume test performed on dozens or hundreds of machines by specialized software testers.

Regardless of scope, the testing of software must be closely managed, especially when relying on automated tools to perform the tests. Test code and test scripts frequently rely on specific files being available to a test machine, either resident on the test machine itself, or available to the machine via a network connection. The location of these files is usually stored as a hard-coded file location, usually including a network name, a directory path, and a file name. These necessary files may include specific compiled code (e.g., a dynamic linked library (DLL) file) or other types of helper files (e.g., a text file, data file, document, etc.).

When a necessary file is unavailable to the test machine, it may cause any number of problems. This situation may occur, for example, if the file is moved or deleted, or if the machine upon which the file is stored becomes unavailable. When the file is not found, the test results may be corrupted, or more likely, the test will simply fail. In a setting where multiple tests rely on the same file, the unavailability of that file may result in the failure of multiple tests. Even when a necessary file is properly accessible, in larger test environments, when dozens or hundreds of machines must access the file, too many file requests may needlessly slow the machine storing the file.

Hard-coded file locations also lack flexibility needed in large test environments. Multiple versions of a test may be used to coincide with different builds of a software application being tested. Each test may use a revised file from a different location, forcing regular updates to the hard-coded file location. At a minimum, code would need to dynamically determine a path location based on factors such as build number, platform, debug mode, and so forth.

It is with respect to these and other considerations that the present invention has been made.

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

Embodiments provide for file handling in a remote execution setting, such as a software test environment. A test client receives a set of instruction which includes test code and at least one indirect reference to a file. The indirect file reference is modified to create an actual file path including parent location information (e.g., a root path). An attempt is then made to access the file using the actual file path.

Additional embodiments provide for controlling a software test run. A test controller receives a request to execute the test run and queries a data store for information associated with the test run. The received results, including a root path, a token identifier, and a set of instructions, are transformed into a message for delivery to one or more test clients. Results are then received from the one or more test clients.

These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

The foregoing brief summary of the invention, as well as the following detailed description, is better understood when read in conjunction with the accompanying drawings, which are included by way of example, and not by way of limitation with regard to the claimed invention. In the accompanying drawings, the same or similar elements are labeled with the same reference numbers.

FIG. 1 depicts an exemplary computing operating environment.

FIG. 2 depicts a system for testing software.

FIG. 3 depicts a process flow for initiating a software test run.

FIG. 4 depicts examples of a tokenized path and an actual file path.

### DETAILED DESCRIPTION

A software test application may automate the test process, utilizing aliases or indirect references to files in order to abstract their location and prevent problems associated with hard-coded file locations. Additional functionality helps for testing by providing multiple prioritized locations where a file may be found.

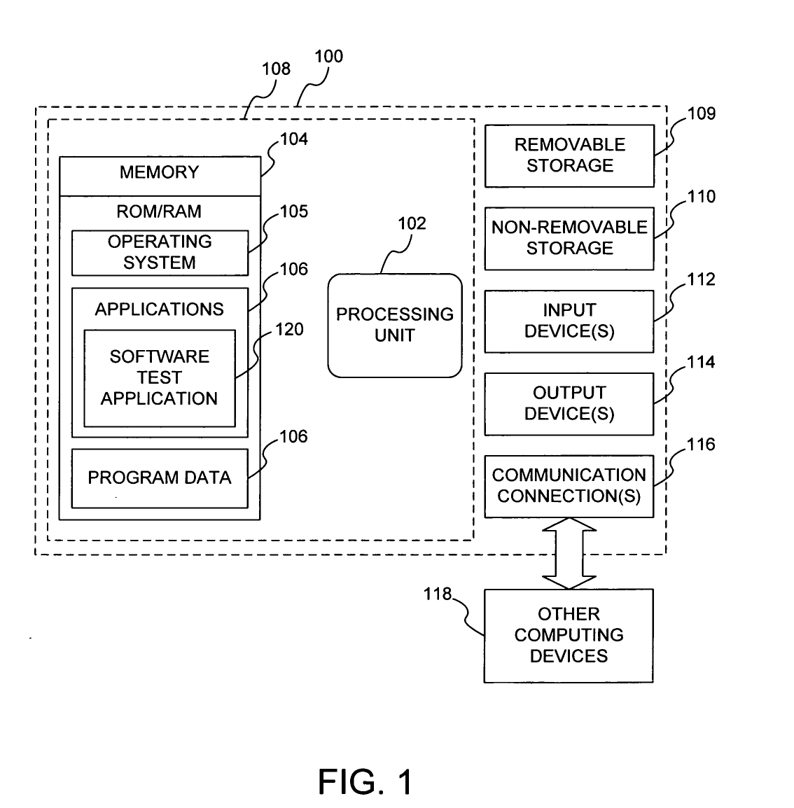

With reference to FIG. 1, the embodiment shown may include a computing device, such as computing device 100. In a basic configuration, computer device 100 may include at least one processing unit 102, and memory 104. Depending on the configuration of the computer device, memory 104 may be volatile (e.g., Random Access Memory (RAM)), non-volatile (e.g., Read-Only Memory (ROM), Flash, etc.), or some combination thereof. Memory 104 may serve as a storage location for operating system 105, one or more applications 106, and may include program data 107, as well as other programs. In one embodiment, applications 106 may include software test application 120.

Although the basic computing device configuration is contained within dashed-line box 108, computing device 100 may include additional features and functionality. For example, computing device 100 may include additional data storage components, including both removable storage 109 (e.g., floppy disks, memory cards, compact disc (CD) ROMs, digital video discs (DVDs), external hard drives, universal serial bus (USB) key drives, etc.) and non-removable storage 110 (e.g., magnetic hard drives).

Computer storage media may include media implemented in any method or technology for storage of information, including computer readable instructions, data structures, program modules, or other data. Memory 104, removable storage 109, and non-removable storage 110 are all examples of computer storage media. Further examples of such media include RAM, ROM, electrically-erasable programmable ROM (EEPROM), flash memory, CD-ROM, DVD, cassettes, magnetic tape, magnetic disks, and so forth. Any such computer storage media may be accessed by components which are a part of computing device 100, or which are external to computing device 100 and connected via a communications link (e.g., Bluetooth, USB, parallel, serial, infrared, etc.). Computing device 100 may also include input devices 112, such as keyboards, mice, pens, microphone, touchpad, touch-display, etc. Output devices 114 may include displays, speakers, printers, and so forth. Additional forms of storage, input, and output devices may be utilized.

Computing device 100 may also include one or more communication connections 116 which allow the computing device to communicate with other computing devices 118, such as over a network (e.g., a local area network (LAN), the Internet, etc.). Communication media, in the form of computer readable instructions, data structures, program modules, or other data in a modulated data signal, may be shared with and by device 100 via communication connection 116. Modulated data signal may mean a signal that has one or more of its characteristics set or changed in such a manner as to encode information in the signal, and may include a modulated carrier wave or other transport mechanism. Communication connection 116 may be comprised of hardware and/or software enabling either a wired (e.g., Ethernet, USB, Token Ring, modem, etc.) or wireless (e.g., WiFi, WiMax, cellular, acoustic, infrared, radio frequency (RF), etc.) communication conduit with other devices 118.

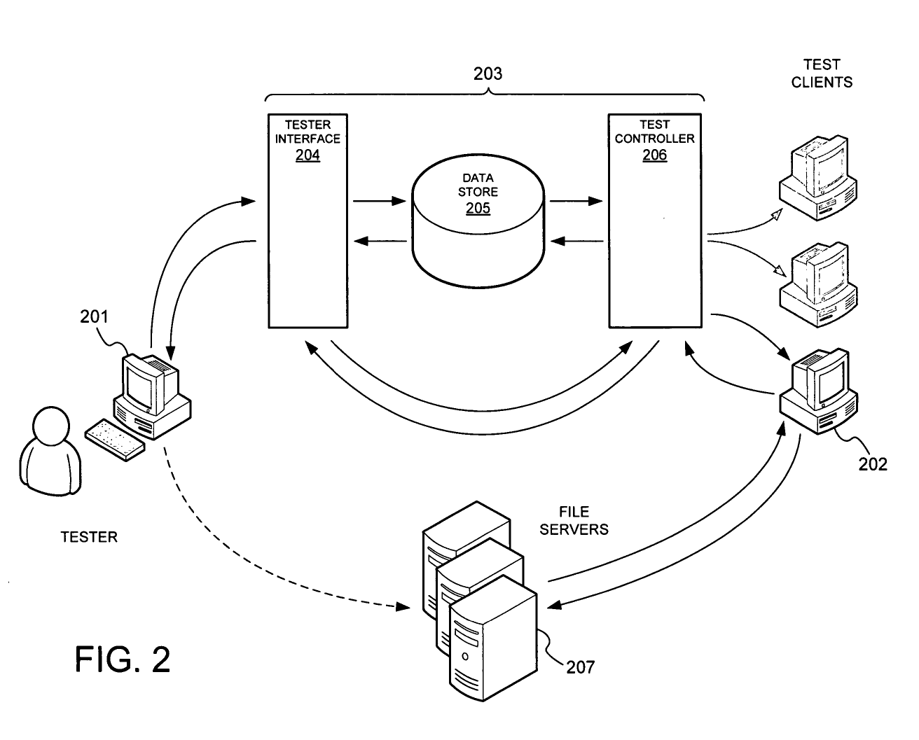

FIG. 2 depicts a system for testing software according to one or more embodiments. The system includes tester machine 201 directing the testing of software on one or more test clients 202. Tester machine 201 may be operated by a software developer or by a quality assurance (QA) or testing specialist. Tester machine 201 may be the location where a software developer creates a software application. Likewise, tester machine 201 may be the location where a test writer develops one or more tests for the software application. Tests may work only with a specific build or revision of the software application, or they may work for multiple versions. Each test may only cover a single piece of functionality, or may exercise multiple functions of an application. The test may be written using, for example, a scripting language or a compiled programming language. The test may be written such that it can be distributed to multiple test clients 202 in order to hasten the results.

In some embodiments, the current build of a software application, along with one or more tests may simply be copied to one or more test clients 202 directly. Helper files needed for the test, including data files, documents, compiled code (e.g., DLLs), may also be copied directly to the test clients 202 from the tester's machine. In an additional embodiment, tests developed on tester machine 202 are managed and/or transferred using test automation system 203.

Test automation system 203 may minimally include a tester interface 204, a data store 205, and a test controller 206. Tester interface 204 may be operated as a local software client on tester machine 201. Tester interface 204 may also be operated via a separate server (not shown) and accessed via a network connection. Tester interface 204 may be accessed by a tester using a web browser. A tester may utilize tester interface 204 to upload test files, including test scripts or code, helper files, compiled code, and so forth. A tester may only upload some or all of the files required for a test. The files may be stored in data store 205, file servers 207, or on other machines. Tester interface 204 may allow a tester to specify parameters for a test run, including operating system, processor, build number, number of test clients, helper files, expected results, and so forth. Tester interface 204 may further allow a tester (and others) to initiate a test run, and to view and analyze results of a particular test run.

Data store 205 may be composed of a database system, including a relational database, an object database, or some other form of database (e.g., text files, spreadsheets, etc.). Data store 205 may reside on the same machine as tester interface 204 (including tester machine 201 itself). Data store 205 need not be composed of a single database, but may encompass multiple databases, files, servers, and locations. Data store 205 may store the test run parameters as indicated above and may also store files and data required for a test run. Further, data store 205 may store information about test clients 202, including platform, specifications, and information about past and future test runs. Data store 205 may also store the results of tests, including test data or files outputted by a test run, or performance indicators such as successful completion and time to completion.

Test controller 206 may reside on the same machine as data store 205 (including tester machine 201), or may reside on separate machines in communication with data store 205 and tester interface 204 using a network connection. Other configurations may be available. In a given test environment, more than one test controller 206 may be utilized to dispatch test runs. For example, a given test controller 206 may be responsible for test runs on a particular subset of available test clients 202. Test controller 206 may initiate and track test runs, as provided by a tester via tester interface 204. Test controller 206 may copy all information and files to test clients 202, or may simply pass along a minimal amount of information, and allow test clients 202 to individually copy required files before initiating a test. During and upon completion of a test, each test client 202 may supply feedback and results to test controller 206, which may in turn store feedback and results in data store 205. Likewise, test controller 206 may also communicate to tester interface 204 that a test is running and/or complete so that a tester can be notified of test status.

As noted above, a test client 202 may receive everything it requires to run a test directly from test controller 206. Alternatively, test controller 206 may merely communicate with software on the test client 202, providing information and/or test code for a test to be run, including all the information required for the test client to identify and/or retrieve necessary files itself. This may include retrieving files from its own hard drive, from file servers 207, from developer machine 201, from data store 205, and from other locations.

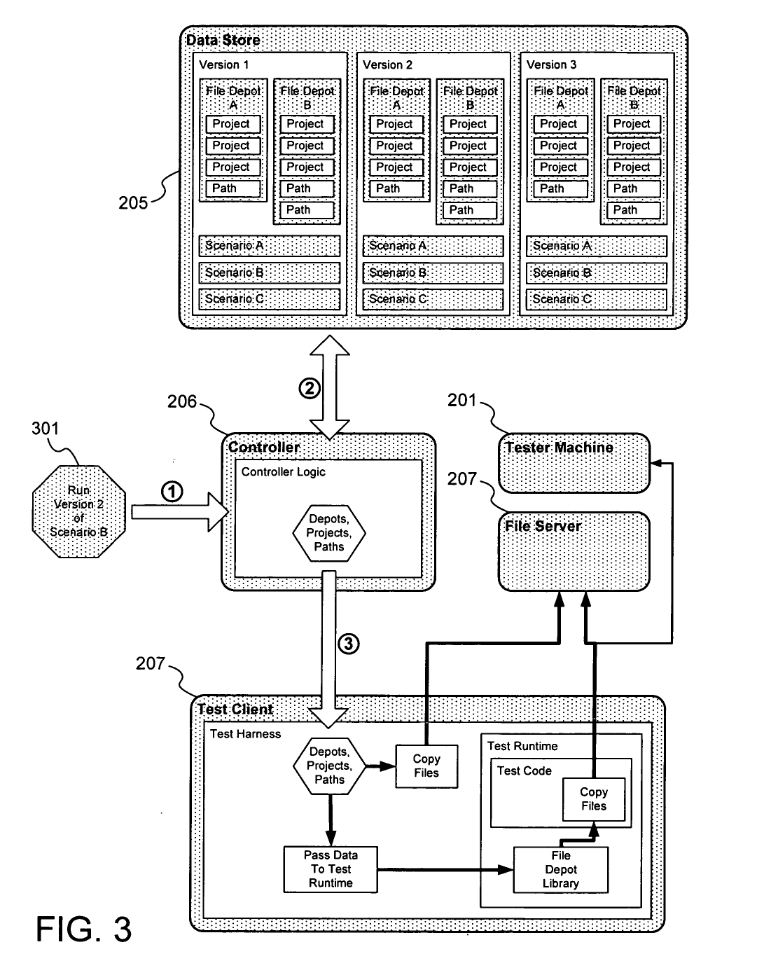

FIG. 3 depicts an example of a process flow upon initiation of a test run in systems similar to the one described above. Here, the process is initiated by command 301 requesting a software test run of version 2 of scenario B for a particular project or group of projects. Essentially, multiple versions of the project may exist in data store 205, and along with each version may be one or more scenarios associated with test code to test different aspects of the projects or project. This request may be directly made by a user, either directly to controller 206, or via tester interface 204 (e.g., via a website). Additionally, command 301 may request a test run automatically on a scheduled basis, or automatically based on a sequence of tests being run. The request may be a direct call made to the controller logic using, for example, an object method call, or a remote procedure call. Other methods of communication are known to those of skill in the art.

The controller logic in controller 206 processes command 301 and then queries data store 205. Here, data store 205 is shown to include information related to three versions of test collections. Each test version in this example includes two file depots (A and B), and each file depot may be associated with different projects and paths. Each depot may be associated with one or more root paths under which test version files may be found. Here, the file depots may be setup to track different kinds of files. For example, file depot A may track compiled code, whereas file depot B may track non-compiled or helper files required for a test. Each version may additionally include scenarios (here A, B, and C) which contain or indicate a location for the test code which actually makes up a test scenario.

A file depot may include one or more root paths. Each project may represent a particular subdirectory under the one or more root paths associated with a depot. A project may be associated with a particular software application or software component, where multiple software components may be managed within each file depot. Paths may associate file “tokens” with file location information. Tokens may include test parameters such as build type, platform type, or other values that may change from one test execution to another. Path and location information may include network names, uniform resource locators (URLs), subdirectories, and other location information.

It should be noted that although the database is shown having multiple versions containing multiple file depots, the actual structure or logical layout of the database need not be structured this way. Versions may allow changes to be made to future tests without modifying older tests. When creating a new version, data and code can be copied forward automatically. Likewise, changes made to code or data associated with a particular version may be propagated to other versions using a batch capability.

The query or queries sent by controller 206 to data store 205 may be in the form of structured query language (SQL) statements, extensible markup language (XML) queries, or other formats. The results of the query may be returned to the controller in one or more result sets including depots, scenarios, projects, paths, and so forth. The information may then be repackaged along with test instructions for delivery to one or more test clients 207 as a message. For example, pertinent information may be supplied to test client 207 in the form of an XML message.

Software on test client 207 receives the message from controller 206. The message, including any file depot related information, may be unpacked by a test harness responsible for managing execution of a test. The test harness receives commands from the controller and sends test results back to the controller. The test harness may use file depot information in a number of ways. One way is to perform file copies as instructed by the controller. These file copies may be bootstrap operations needed to begin a test, for example, copying a test scenario file to the test client 207. The scenario file may include data which communicates test operations to be performed by the test runtime, which is responsible for managing the actual execution of a test.

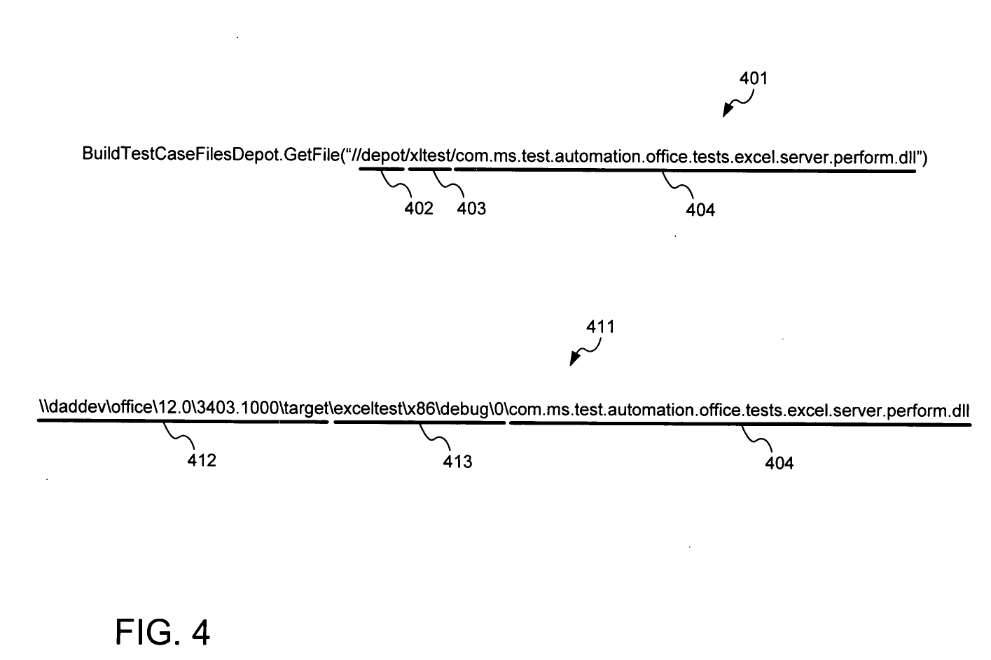

In performing the file copies as instructed, the test harness may make use of “file depot logic” to locate the needed files. File depot logic may be encapsulated in a software application or software component designed for, among other tasks, managing file handling in a software test environment. File depot logic may convert an indirect file reference into an actual file path. FIG. 4 depicts an example of a tokenized path 401 (indirect file reference) and an example of an actual file path 411. The actual file path 411 may represent a possible physical location for a file, accessible to test client 207 via a network connection, for example. The tokenized path 401 is an example of how the same file may be referenced by an author of test code. Test client 207 may receive tokenized path 401 as part of an instruction received from controller 206. The instruction may be written in a scripting language (e.g. Visual Basic script), a compiled language (e.g. C++), a semi-compiled language (e.g., Java or C#). The instruction may include the tokenized path 401, which includes depot name 402, project name 403, and file name 404. Although depicted here in a particular order with particular tokens, other tokens may be used to represent similar attributes. The tokenized path indirectly references the file without being associated with a particular location on a machine or on a network.

When software on test client 207 encounters the instruction, it may convert tokenized file path 401 into actual file path 411. To perform this conversion, software on test client (e.g., test harness code, test runtime code, test code, etc.) may use the depot data passed as a part of the message from the controller. This data may include a root path, also be referred to as parent location information (e.g. “\\daddev\office”), a major and minor point version (e.g., “12.0”), a build number (e.g., “3403.1000”), static information (e.g., “target”), a project name (e.g., “exceltest”), a project platform (e.g., “x86”), a build type (e.g., “debug”), a specific locale/language (e.g., “0”). The tokens within the tokenized file reference may be expanded by the file depot logic to assemble the actual file path. For example, the depot token 402 (“depot”) may be replaced by a root concatenation 412 of the root path, the major and minor point version, the build number, and static path information. Further, the project token 403 (“xltest”) may be replaced by a project concatenation 413 comprised or a project name (“exceltest”), a platform (“x86”), a build type (“debug”), and a locale (“0”). Combining these two concatenated strings with the file name 404 produces a full path to a possible location of the needed file.

It is again important to note that the tokens and attributes utilized in the example of FIG. 4 are merely intended as examples. Alternate combinations of tokens may be utilized to create an indirect reference to a file needed for testing. Further an alternate combination of test parameters, and even arbitrary values, can be utilized to create the actual file path. Although the actual file path shown here utilizes a network name and directory structure, any form of file locator may be utilized, including drive designations, Internet domains, and so forth.

Once a tokenized file path has been converted to an actual file path, the file (if present on the named file server 207) can be copied onto test client 207 for eventual use by the test runtime and test code. Returning to FIG. 3, another use for the test harness is to transform the file depot information into a format (e.g., XML) understandable by the test runtime. Once file depot information has been converted into the test runtime format, the test harness may instruct the test runtime to load the formatted information, to load a scenario file, and to begin execution of the test. During test execution, test code may need to copy a file in a fashion similar to that previously described. A needed file (e.g., a saved document) may be copied from file server 207 using file depot logic.

When copying the needed file, file depot logic may search multiple locations before finding and retrieving the file. In other words, a particular file may be stored in one of many locations, and the file depot logic can maintain a prioritized list of paths in which to search for the file. This may be used to provide fall back locations in which a given file may be stored, in case, for example, the primary file server has crashed or is otherwise unavailable. This functionality may also be utilized to provide a “local override” for particular files. For example, file depot logic may first search a directory on a test developer's machine 201 before proceeding to search file servers and other locations. In this manner, a test developer can temporarily force a test to use a locally modified copy of the file, allowing a test developer to try test modifications without impacting the execution of other tests. Once the file and test have been perfected, the file can be sent to data store 205 or file server 207 for proper use.

Using file depot logic, a test client 202 may receive indirect references to files and convert the indirect references into one or more actual file locations. Software on test client 202 may then convert the indirect references into actual file locations using test parameter information. Moreover, in a test run involving multiple test clients, each test client may be provided with a different root path or different prioritized list of root paths. This can help prevent overloading of a particular file server. Moreover, test clients may work cooperatively to cache files, allowing test clients to access files from each other rather than from a primary file server. Different caching and file distribution schemes are available due to the decoupling of files from particular hard-coded locations.

Aspects of file depot logic may be modified by testers and test developers via tester interface 204. This includes the setup of prioritized root paths, so that individual testers can override any particular location as needed. Another feature of file depot logic is the ability to clean up files after a test is complete. Because all files can be copied using the same or similar logic, the files can easily be tracked, and removed if necessary upon completion of the test.

Although the embodiments described above deal with software test environments, the methods and systems described above can be utilized in any environment requiring remote execution of software, especially where file locations change frequently. It should be noted that although multiple machines and server are described throughout, the functional components may be implemented on a single machine, acting as a tester interface, data store, test controller, test client, and even file server. This may enable a tester to work “offline” and test code against the system.

While methods and systems embodying the present invention are shown by way of example, it will be understood that the invention is not limited to these embodiments. The methods and systems described are merely examples of the invention, the limits of which are set forth in the claims which follow. Those skilled in the art may make modifications, particularly in light of the foregoing teachings.

We claim:

1. A computer-implemented method for automating file handling in a remote execution setting, the method comprising:
receiving a first set of instructions, including:
instructions for executing a second set of instructions, and
instructions which include an indirect reference to a file;
receiving first parent location information for a first parent directory under which the file may be located;
resolving a first full path to the location of the file by combining a first portion of the indirect file reference with a second portion of the first parent location information; and
attempting to access the file using the first full path.

2. The computer-implemented method of claim 1, the method further comprising:
receiving second parent location information for a second parent directory under which the file may be located;
attempting to access the file under the first parent directory;
determining that the file is unavailable at the first parent directory;
resolving a second full path to the location of the file by combining the first portion of the indirect file reference with a third portion of the second parent location information; and
accessing the file using the second full path.

3. The computer-implemented method of claim 1, wherein the second set of instructions comprise instructions for testing a software application.

4. The computer-implemented method of claim 3, the method further comprising:
receiving attribute information about the software application; and
utilizing the attribute information when resolving the first full path, wherein a portion of the first full path includes an attribute of the software application.

5. The computer-implemented method of claim 4, wherein attribute information comprises one of a root path, a build number, and a platform.

6. The computer-implemented method of claim 1, wherein the first full path indicates a file location on another machine also receiving the first set of instructions.

7. The computer-implemented method of claim 1, wherein the first full path is indicative of a file located on a remote computer.

8. The computer-implemented method of claim 7, the method further comprising:
copying the file to a locally accessible location;
executing the second set of instructions; and
removing the file from the locally accessible location.

9. A computer-implemented method for controlling a software test run, the method comprising:
receiving a request to execute the software test run;
querying a data store for information associated with the software test run;
receiving one or more query results from the data store, wherein the query results include:
a first root path,
a token identifier, and
a set of instructions for test client execution;
transforming a portion of the one or more query results into a message having a format readable by a first test client;
transmitting the message to the first test client for execution; and
receiving from the first test client a first test result.

10. The computer-implemented method of claim 9, the method further comprising:
transmitting the message to a second test client for execution; and
receiving from the second test client a second test result.

11. The computer-implemented method of claim 9, the method further comprising:
receiving a second root path from the data store; and
modifying the message to include the second root path.

12. The computer-implemented method of claim 11, the method further comprising:
modifying the message to give a priority to the first root path over the second root path.

13. The computer-implemented method of claim 9, wherein the format readable by the first test client is extensible markup language (XML).

14. The computer-implemented method of claim 9, wherein the query results further include:
a software version,
a computing platform, and
a build type.

15. A system for testing software, wherein the system comprises:
a processor;
a network interface, in communication with the processor, wherein the network interface permits communication between the system and a remote computer; and
a memory, storing instructions executable by the processor, wherein the instructions comprise:
receiving from the remote computer test code for execution during a test run, wherein the test code includes an indirect reference to a file,
receiving via the network interface test parameters, including a first root path,
determining a path for the file by modifying the indirect reference, wherein determining the path includes modifying the indirect reference to include the first root path,
attempting to access the file at a first location indicated by the path,
executing the test code, and
transmitting a test result via the network interface.

16. The system of claim 15, wherein the instructions further comprise:
receiving via the network interface a second root path,
receiving an error when attempting to access the file at the first location indicated by the path,
modifying the path by replacing the first root path with the second root path,
attempting to access the file at a second location indicated by the path, and
accessing the file at the second location.

17. The system of claim 15, wherein the instructions further comprise:
determining a path for the file by modifying the indirect reference, wherein determining the path includes using test parameters as portions of the path.

18. The system of claim 17, wherein test parameters comprise one of a build number, a computing platform, and a build type.

19. The system of claim 15, wherein the second root path references a location on a computer used by an author of the test code.

20. The system of claim 15, wherein receiving via the network interface test parameters comprises receiving a message from the remote computer composed using extensible markup language (XML).
